(19) United States
(12) Patent Application Publication
(10) Pub. No.: US 2024/0262218 A1
(43) Pub. Date: Aug. 8, 2024

(54) MOTOR VEHICLE-SIDE INDUCTION CHARGING DEVICE

(71) Applicant: MAHLE International GmbH, Stuttgart (DE)

(72) Inventors: Mike Boettigheimer, Kornwestheim (DE); Stefan Hirsch, Stuttgart (DE); Christopher Laemmle, Stuttgart (DE); Timo Laemmle, Kernen (DE); Florin Moldovan, Stuttgart (DE); Holger Schroth, Maulbronn (DE); Martin Steinbach, Waiblingen (DE); Markus Watzlawski, Esslingen (DE)

(21) Appl. No.: 18/565,511

(22) PCT Filed: May 24, 2022
(86) PCT No.: PCT/EP2022/064080

§ 371 Date: Nov. 29, 2023

(30) Foreign Application Priority Data
May 31, 2021 (DE) 102021205539.7

(51) Int. Cl. B60L 53/12; B60L 53/302; H01F 38/14

(52) U.S. Cl. CPC B60L 53/12; B60L 53/302; H01F 38/14; B60L 2270/147

(57) ABSTRACT

A vehicle-side induction charger for use in an induction charging unit of a vehicle is disclosed. The induction charger includes an induction coil device for contactless energy transmission, an electronic device set up for operating the induction coil device, a cooling device set up for cooling the induction coil device and/or the electronic device, on which the electronic device is arranged on the one hand and the induction coil device on the other hand, and with a cover enclosing the electronic device at least in sections. The induction coil device has a flat coil carrier and an electrically conductive flat coil consisting of coil windings arranged on it. The cover is arranged on the flat coil carrier or on the cooling device in such a way that it spans the electronic device at least in sections or completely.

### CROSS-REFERENCE TO RELATED APPLICATIONS

This application claims priority to International Patent Application No. PCT/EP2022/064080 filed May 24, 2022, which also claims priority to German Patent Application DE 10 2021 205 539.7 filed May 31, 2021, the contents of each of which is hereby incorporated by reference in its entirety.

### TECHNICAL FIELD

The invention relates to a vehicle-side induction charger.

### BACKGROUND

For contactless energy transfer between an induction charging unit with induction charger arranged on the vehicle side and a counter-induction charging unit anchored on the ground side, an optimum magnetic coupling between them must be set in order to realize efficient energy transfer. This is usually achieved mainly through constructive coordination of the components involved. However, if the vehicle-side induction charger is or is to be used in motor vehicles of different types, wherein, for example, a distance between the vehicle-side induction charging unit and a floor-side counter-induction charging unit changes, at least the vehicle-side induction charger must be structurally adapted to the framework conditions specified by this new installation situation or by the changed installation location. However, the adaptations to be made for this are associated with relatively high costs, despite the desire for cost-effective induction charging systems.

### SUMMARY

The object of the invention is therefore to provide or indicate an improved or at least another embodiment of a vehicle-side induction charger.

In the present invention, this task is solved in particular by the object of the independent claim(s). Advantageous embodiments are the subject of the dependent claims and the description.

The basic idea of the invention is to give the components of a vehicle-side induction charger an innovative design that allows the respective component to be adapted to a variety of predetermined framework conditions with practically no or at least only minimal design effort.

According to the invention, a vehicle-side induction charger is provided for this purpose, which is intended in particular for use in an induction charging unit of a motor vehicle which is set up for charging a traction battery and has the induction charger, and can be used in such a unit. The term “vehicle-side” can be understood here as a general assignment of the induction charger to the motor vehicle, preferably, for example, the induction charger is mounted on the underbody of the motor vehicle. The induction charger according to the invention has an induction coil device for contactless energy transfer, an electronic device set up for operating the same, a cooling device set up for cooling the induction coil device, and/or the electronic device, on which the electronic device is arranged on the one hand and the induction coil device on the other hand, and a cover enclosing at least the electronic device at least in sections. The induction coil device in question has a flat coil carrier and an electrically conductive flat coil of coil windings arranged on it, in particular with a predetermined coil geometry. The said cover is arranged in contact with the flat coil carrier and/or the cooling device and is fixed there if necessary, thereby spanning the electronic device and expediently, at least in sections, the flat coil carrier and/or, at least in sections, the cooling device. Furthermore, in a height direction orthogonally pointing away from the flat coil carrier and/or the cooling device, the cover defines a vertical axis orthogonally aligned with respect to the flat coil carrier and/or the cooling device. It is intended that the induction coil device, the cooling device, the electronic device and the cover each rotate about the vertical axis and can therefore be positioned in different angular positions in relation to the vertical axis. The induction coil device, the cooling device, the electronic device, and the cover can be fixed together in their respective angular positions. This allows the induction charger to be flexibly constructed, in particular it can be modularly adapted to a motor vehicle. Furthermore, the cover can protect the electronic device from environmental influences, in particular it is possible to shield the electronic device against electromagnetic interference. Overall, this optimizes the magnetic coupling between the induction charger and a bottom-side counter-induction charging unit, which means that contactless energy transfer can be achieved relatively trouble-free and, in particular, independently of the general conditions specified by the installation location of the induction charger.

It is expedient if angles of 5°, 10°, 15°, 20°, 25°, 30°, 35°, 40°, 45°, 90°, or 180° are spanned between the said angular positions in which the induction coil device, the cooling device, the electronics device, and the cover can be positioned, so that the induction coil device, the cooling device, the electronics device, and the cover can be positioned in 5°, 10°, 15°, 20°, 25°, 30°, 35°, 40°, 45°, 90° steps with respect to the vertical axis and fixed to one another. This has the advantage that the position of these components, and possibly that of the power electronics and thus the position of the cover platforms, can be adjusted as required.

It is useful if the said cover defines a vertical axis orthogonally aligned with respect to the flat coil carrier or the cooling device in a height direction pointing orthogonally away from the flat coil carrier and/or the cooling device and if the cover is adapted to an outer contour of the electronic device. The outer contour can be realized by electronic components of the electronic device. In particular, the cover can have areas of different dimensions in the height direction. This makes it possible to react flexibly and locally to different geometries of the installed electronic components. The cover is adapted to the outer contour of the electronic device by the cover spanning the electronic device with a wall or horizontal wall sections extending transversely to the vertical axis and with vertical wall sections extending parallel to the vertical axis, the wall, and/or the vertical wall sections and/or the horizontal wall sections each having a predetermined or predeterminable gap distance between them and at least one of said electronic components of the electronic device. Such electronic components of the electronic device are realized in particular by electrical supply connections, e.g., by high-voltage plug connections and/or low-voltage plug connections, and in particular by electronic components, e.g., microchips and/or capacitors, or by printed circuit boards, which will be discussed below. The specified or predeterminable gap distance is intended to ensure that there is sufficient space between the cover or its vertical wall sections and/or horizontal wall sections and the electronic components of the electronic device, e.g., for electrical/electromagnetic insulation and/or clearance for mounting the cover. It is at least conceivable that the gap distance of large zero is up to 1 mm or up to 5 mm or up to 10 mm, whereby a relatively narrow gap is realized. The gap can be filled with air or, in particular to support or achieve the aforementioned electrical/electromagnetic insulation, filled in sections or completely with a hardenable casting compound. As a result, the cover is adapted to the outer contour, which is predetermined, so to speak, by the electronic components of the electronic device. The cover can therefore be relatively compact.

It is also useful if a longitudinal axis orthogonal to the vertical axis and a transverse axis orthogonal to the vertical axis and the longitudinal axis are defined on said vertical axis. The longitudinal axis can define a longitudinal direction and the transverse axis a transverse direction.

Furthermore, it may be provided that the horizontal wall sections and/or the vertical wall sections of the cover are assigned electrical supply connections of the electronic device and/or coolant connections of the cooling device. These can penetrate the same, in particular transversely to the vertical axis and in particular completely. Alternatively or additionally, the horizontal wall sections and/or the vertical wall sections can have a predetermined or predeterminable minimum gap distance between them and the electrical supply connections and/or the coolant connections. By means of said electrical supply connections, the electronic device can appropriately be electrically contacted or contactable, so that, for example, communication of the electronic device with a counter-electronic device, which in particular has a traction battery or communicates with such a device, of the motor vehicle can be realized. The electrical supply connections can be realized, for example, by high-voltage plug connections and/or low-voltage plug connections. The coolant connections are conveniently formed by fluid pipes or fluid hoses through which cooling fluid flows or can flow during operation of the cooling device. The specified or predeterminable minimum gap distance is intended to ensure that there is sufficient clearance between the cover and the components in question, e.g., for electrical/electromagnetic insulation and clearance for mounting the cover. It is at least conceivable that the minimum gap distance, in particular large zero, is up to 1 mm or up to 5 mm or up to 10 mm. Alternatively, it can be provided that the minimum gap distance is greater than or equal to the gap distance described above. The resulting gap can be filled with air or, in particular to achieve the aforementioned electrical/electromagnetic insulation, filled with a casting compound in sections or completely. This allows the cover to be adapted to the existing electrical supply connections of the electronic device and/or the coolant connections of the cooling device and shield them. Overall, the cover is therefore relatively compact. Furthermore, it is conceivable that the cover has a base height over large areas of the vertical wall sections and/or the horizontal wall sections, which is to be understood in the height direction with regard to the electronic device or the electronic components thereof, which ensures overvoltage and insulation of the electronic device. The basic height can be predetermined, e.g., several millimeters.

Furthermore, the cooling device can be realized by a cooling plate which has a plurality of initially closed feed-through positions, two of these initially closed feed-through positions being opened during assembly of the induction coil device in order to create passages for coolant connections of the cooling device. As a result, the position of the coolant connections can also be realized independently of the position of the other components of the induction coil device and in particular independently of the position of the strand feed-through from the flat coil through the cooling device to the electronic device.

The horizontal wall sections and/or the vertical wall sections of the cover can be guided around the electrical supply connections of the electronic device and/or the coolant connections of the cooling device, forming an electrical connection base s and/or a cooling connection base with a minimum gap distance. The electrical connection bases and/or the cooling connection bases can protrude in the height direction over the cover, in particular its remaining vertical wall sections and/or horizontal wall sections, away from the cooling device and the flat coil carrier. The electrical connection sockets and/or the cooling connection sockets are conveniently arranged on the edge of the cover and in particular on opposite sides of the cover.

Furthermore, the cover can be realized by a circular cover or a square cover or a rectangular cover or an octagonal cover. It may also be possible to select irregular octagonal cover shapes for the cover instead of circular covers, square covers, rectangular covers, or octagonal covers. This means that the cover can be or can be adapted to many conceivable shapes of the spanned electronic device, allowing the induction charger to be used relatively flexibly. The cover can be manufactured, in particular independently of its cover shape, as part of a casting process, e.g., aluminum die casting or injection molding, whereby its cover shape can be adapted relatively easily by adapting the casting tools.

As mentioned, the cover can define a vertical axis orthogonally aligned with respect to the flat coil carrier or the cooling device in a height direction pointing orthogonally away from the flat coil carrier and/or the cooling device, wherein the cover is designed to be point-symmetrical with respect to the vertical axis or mirror-symmetrical with respect to a longitudinal axis orthogonal to the vertical axis. Preferably, the cover can have double or quadruple symmetry with respect to these axes. This means that it can be manufactured using relatively simple tools and is therefore cost-effective.

Conveniently, the cover has an integral and at least in sections or completely circumferential fixing flange with respect to the vertical axis, which, when the cover is mounted on the flat coil carrier or on the cooling device, faces the flat coil carrier or the cooling device and is arranged in contact therewith. The fixing flange has several through-holes for fixing screws. The through-holes are arranged on the fixing flange around the vertical axis and pass through it parallel to the vertical axis, wherein they are each fitted with a fastening screw for detachable fixing of the cover to the flat coil carrier or the cooling device. The fastening screw can be screwed into threaded holes provided in the cooling device or in the flat coil carrier.

Furthermore, the fixing flange can take on or have different cover shapes. Accordingly, a cover realized as a circular cover can form a circumferential ring flange, a cover realized as a square cover can form a circumferential square flange, a cover realized as a rectangular cover can form a circumferential rectangular flange, a cover realized as an octagonal cover can form a circumferential octagonal flange. This means that covers with different geometries can be easily and securely attached to the flat coil carrier or the cooling device.

The cover can usefully be bonded fluid-tight to the flat coil carrier and/or the cooling device. For example, an adhesive used for bonding can be applied at least selectively or circumferentially to a contact surface of the fixing flange of the cover. This protects the electronic equipment enclosed or spanned by the cover from moisture, for example. Furthermore, the said through-holes of the fixing flange can be designed to be point-symmetrical with respect to the vertical axis or mirror-symmetrical with respect to a longitudinal axis orthogonal to the vertical axis. This allows the fixing flange to be mounted in several angular installation positions, i.e., in several installation positions, on the flat coil carrier or on the cooling device. The angled mounting positions span angles of e.g., 15° or 45° or 90° or any other angle. This makes it possible for the fixing flange to rotate around the vertical axis by a certain predetermined or preset angle depending on the selected symmetry of the through holes and to be mounted in different angular installation positions on the flat coil carrier or on the cooling device. This allows, for example, the orientation of electrical supply connections, coolant connections, electrical connection sockets, and/or cooling connection sockets assigned to the cover to be optimized in accordance with framework conditions specified by the vehicle. For example, it may be possible to rotate the cover relative to the vertical axis in 15°, 45°, or 90° steps.

Furthermore, it is provided that the electronic device of the induction charger has a single printed circuit board, several separate printed circuit boards, or four separate printed circuit boards, each of which is electrically connected to one another via electrical conductors. These printed circuit boards are suitably adapted geometrically to the cover described above and spanned by the same, so that the cover has a shielding protective effect on the printed circuit boards, so that the printed circuit boards can be operated relatively trouble-free, protected from electromagnetic interference, for example, whereby a combinatorial interaction is created as a result of which the operation of an induction charger is more trouble-free and therefore safer. In any case, it is envisaged that a first printed circuit board of these printed circuit boards forms a capacitor board, which in practice is referred to as a TMN board, which has several separate capacitor banks. The capacitor banks can each have electrically connected individual electrical capacitances, wherein in the assembled state of the induction charger a single capacitor bank or several capacitor banks or all capacitor banks of the first printed circuit board are electrically conductively interconnected. This allows an overall capacitance to be formed, which is electrically connected to the aforementioned flat coil and interacts with it in order to optimize the magnetic coupling of the flat coil. It is conceivable that the printed circuit boards of the electronic device only have a single first printed circuit board or alternatively several first printed circuit boards. Furthermore, it may be provided that a second printed circuit board of these printed circuit boards forms a high-voltage signal processing board, which is referred to in practice as an HV board. It implements high-voltage signal processing and high-voltage signal conversion in order to charge or discharge a traction battery of a motor vehicle, for example. The second circuit board can in particular have an AC/DC converter or be formed by one. It is conceivable that the printed circuit boards of the electronic device only have a single second printed circuit board or alternatively several second printed circuit boards. Furthermore, it may be provided that a third printed circuit board of these printed circuit boards forms a further capacitor board, which in practice is referred to as a TMN board, which has at least one adjustable capacitor in order to optimize the magnetic coupling of the flat coil. It is conceivable that the printed circuit boards of the electronic device only have a single third printed circuit board or alternatively several third printed circuit boards. Furthermore, it may be provided that a fourth circuit board of these circuit boards forms a communication board, which in practice is referred to as a COM board, forming a control and/or regulation for the operation of the flat coil. It can have control and/or regulation electronics for this purpose. It can also feature safety systems and assistance systems. The separate circuit boards described have the advantage that when they are integrated into the induction charger, it is possible to react flexibly to the given conditions at an installation location, e.g., to the positions of vehicle-side counter-electrical supply connections. An electrical connection between the printed circuit boards described above can be made using rigid or flexible conductors.

The electrical conductors can form high-voltage conductors, hereinafter HV conductors, which can be part of the induction coil device that communicates electromagnetically with the counter-induction charging unit and can therefore be implemented as a standardized connection. The printed circuit boards to be connected to these HV conductors, in particular the first, second, third, or fourth printed circuit boards mentioned above, are therefore designed in such a way that the connection with these standardized HV conductors can also be implemented in different installation positions. This means that the electromagnetic induction coil device remains unchanged even if the PCBs are distributed differently.

In order to ensure communication between said printed circuit boards and to be able to mount them relatively flexibly and possibly in different positions, it may be provided that the electrical conductors of the electronic device form low-voltage conductors, hereinafter LV conductors, which form low-voltage communication connections, also referred to as LV communication connections. At least one LV communication connection of these LV communication connections can be formed by a flexible conductor and electrically connect the first, second, third, or fourth printed circuit board to the first, second, third, or fourth printed circuit board. Both the standardized HV connections and the flexible LV connections have the advantage that the electronic device can be adapted in particular to the magnetic coil properties of the aforementioned flat coil and/or to the framework conditions specified in a motor vehicle.

It is useful if the printed circuit boards can be positioned in different angular positions by rotating them about said vertical axis and/or rotating them about a transverse axis perpendicular to the vertical axis. The printed circuit boards can be electrically connected to each other by means of said high-voltage conductors and/or said low-voltage conductors.

Alternatively or additionally, the same high-voltage conductors can be used for the electrical connections between the first, second, and third printed circuit boards, even in different angular positions. This also allows the position of the platforms or bases of the cover and the position of the electrical connections of the circuit boards to be adjusted. It is also helpful to avoid additional interference on the electromagnetic coupling.

Furthermore, all the circuit boards in question can be placed next to each other in any spatial combination. All circuit boards can be realized by a single one-piece base circuit board. It is also conceivable that at least one or more printed circuit boards are separated depending on their respective function or that at least one or more printed circuit boards have additional functions.

Conveniently, the electronic device can have all the electrical and mechanical components required for a charging and/or discharging process of a traction battery of a motor vehicle in order to provide the required charging/discharging functions. Especially, the electronic device can also comprise a control and/or regulation system which manages a charging and/or discharging process of the traction battery.

So that the induction charger can be attached to a motor vehicle cost-effectively and with relatively easy-to-install means, it can be provided that fasteners are assigned to the cover and/or the flat coil carrier and/or the cooling device. By means of these, the induction charger can be attached to a motor vehicle, in particular on the floor and detachably or non-detachably.

It is also useful if fasteners are assigned to the cover and/or the flat coil carrier and/or the cooling device, the positioning and alignment of which can be adapted as desired within predetermined areas of the induction charger, in particular the corners of the cover and/or the flat coil carrier and/or the cooling device and/or the induction coil device, wherein the induction charger can be detachably or non-detachably fastened to a motor vehicle by means of the fasteners. This allows flexible fixation to be achieved without compromising the mechanical integrity of the induction charger. It is expedient that the said areas for the fasteners can be specially reinforced by suitable structural means. There may be more said areas for fasteners on the induction charger than are actually required for fixing it to a motor vehicle, so that at least some said areas are unused when the induction charger is mounted.

Furthermore, it may be provided that the fasteners are formed by several, in particular three or four, separate direct screwing projections arranged on the cover and/or on the flat coil carrier and/or on the cooling device. These direct screwing projections can each have a projection projecting outwards transversely to said vertical axis from the cover and/or from the flat coil carrier and/or from the cooling device radially with respect to the vertical axis, i.e., in said transverse direction, with at least one threaded hole oriented in the vertical direction or a through hole oriented in the same direction. The term “threaded hole oriented in the vertical direction” or “through hole oriented in the vertical direction” can mean that the threaded hole or the through hole of a direct screwing projection is oriented essentially parallel to the vertical axis, which can correspond to a deviation of +/−5%, for example. The threaded hole or the through hole of a direct screwing projection can define a recess center axis. This can be aligned parallel to the vertical axis. This means that the induction charger can be mounted on a motor vehicle with simple means. For example, fastening screws held on the vehicle side can be screwed into the threaded holes or fastening screws can be inserted through the through-holes, which are then screwed into screw points on the vehicle side, i.e., threaded holes and through-holes interact with fastening screws for detachable or, if necessary, non-detachable fastening of the induction charger to the vehicle.

It is expedient to provide that the arranged direct screwing projections are only fixed to one area in their position or connection to the induction charger. Such an area can, for example, represent a corner of the induction charger, wherein the term corner here also includes the areas at a distance of zero to 50 mm or up to 100 mm or up to 150 mm from the geometric intersection of the side surfaces. It is therefore conceivable that a direct screwing projection provided for the corner area is attached exactly diagonally to the corner or is attached in a deviating direction, which is between the diagonal and an axial direction, at a distance of zero to 50 mm or up to 100 mm or up to 150 mm from the geometric intersection of the side surfaces, without restricting the mechanical integrity and in particular the mechanical strength of the induction charger in all mechanical respects (strength, shock, vibration). The internal load-bearing structure of the induction charger is specially designed for this purpose, e.g., by specially reinforcing the corner area of the induction charger. This flexibility means that the induction charger can be adapted quickly and with little effort to many different installation situations in the vehicle.

It is also expedient that at least one threaded hole or a through-hole of a projection or an area provided for a fastening is unused, i.e., free, in the assembled state of the induction charger, so that this threaded hole or this through-hole does not interact with a fastening screw. Furthermore, the direct screwing protrusions or at least the protrusions thereof can be produced as part of a casting process, e.g., an injection molding or die casting process, or by means of other original shaping processes. Furthermore, the direct screw connection protrusions or at least the protrusions of the same can also be subsequently arranged on the cover and/or on the flat coil carrier and/or on the cooling device, e.g., by welding or bonding in a non-detachable manner or e.g., by screwing or other clamping in a form-fit and force-fit detachable manner. The detachable arrangement of the direct screwing protrusions or at least the protrusions has the advantage that repair is relatively simple in the event of damage, wherein the integrity of the induction charger in particular does not have to be impaired.

Furthermore, the direct screwing protrusions or at least the protrusions of the same can be designed to be single or double symmetrical in relation to the vertical axis. It is also conceivable that the direct screwing protrusions or at least their protrusions form a common plane oriented orthogonally with respect to the vertical axis, so that the direct screwing protrusions or at least their protrusions lie at an identical height level, so to speak, towards the body or an underbody of a motor vehicle.

One can at least imagine that two, three, four, five, or six direct screwing projections are arranged on the cover and/or the flat coil carrier and/or the cooling device. It is also possible to imagine an even or odd number of arranged direct screwing projections.

It is also possible that the radially outwardly projecting projections with a threaded hole or through-hole are each realized by a cuboid support arm projecting radially away from the vertical axis. The respective threaded holes or through-holes are arranged at the distal end of a support arm. The term “distal end of a support arm” can mean the free end of a support arm, in the sense that a threaded hole or a through hole is arranged at the free end of a support arm. This allows the connection point to be shifted radially outwards, so that, for example, a certain distance can be maintained between the induction charger and a respective connection point. It is advisable to design the support arms integrally with the cover and/or the flat coil carrier and/or the cooling device; alternatively, they can also be provided as separate units and retrofitted, or they can be formed by components of the cover or the flat coil carrier or the cooling device.

Conveniently, the fasteners can be formed by several, in particular three or four or even more, clamps arranged on the cover and/or on the flat coil carrier and/or on the cooling device. Each clamp can have a clamping body, a spacer arranged loosely on the cover, and/or on the flat coil carrier and/or on the cooling device and projecting radially outwards in relation to the vertical axis, i.e., in the transverse direction, and a fastening screw. In order that the induction charger can be fixed to a motor vehicle, it is expedient that the clamping body is in contact with the cover and/or the flat coil carrier and/or the cooling device, with the spacer being arranged in a sandwich-like manner between the clamping body and a motor vehicle, e.g., its underbody. The clamping body, spacer, and vehicle, e.g., its underbody, are then mutually braced in the vertical direction by means of a fastening screw, e.g., held on the vehicle side, so that the cover and/or the flat coil carrier and/or the cooling device are clamped. This provides a convenient detachable mounting option for the induction charger.

Furthermore, one can imagine that the induction charger is equipped with a stiffener, which can be realized, for example, by at least locally increasing the wall thickness, locally increasing the overall height and/or by adapting the material of the cover and/or the flat coil carrier and/or the cooling device. This has the advantage that the cover and/or the flat coil carrier and/or the cooling device can achieve a relatively high rigidity, i.e., in particular an induction charger without stiffening.

The induction charger can also have a single fastener, which is formed by a carrier arranged on the cover. The carrier can have a support rod, which can be anchored on the vehicle side, and support struts that engage integrally with the support rod and extend in a star shape over the cover, which serve to reinforce the carrier.

This single fastener or fastening point has the advantage that in the event of deformation or twisting of the vehicle structure, no constraining stresses can be introduced into the mechanical structure of the induction charger by several fasteners or fastening points. A single fastener or fixing point can be positioned congruently with the vertical axis of the induction charger. Alternatively, this attachment point can also be located in a position parallel to the vertical axis, e.g., the position of the center of gravity of the induction charger. This single fastening point can, for example, be integrally connected to the cover, wherein the area around the fastening point can be particularly reinforced by one or more ribbed structures or other mechanical measures (e.g., increasing the wall thickness). Alternatively, the fasteners or the fixing point can also be designed in such a way that it can be firmly connected to the cover using other mounting means (e.g., screws).

Conveniently, the flat coil carrier mentioned at the beginning has contiguous grooves into which the coil windings of the flat coil can be inserted along a winding path extending through the grooves, forming a coil winding pattern of the flat coil which specifies the coil properties of the flat coil and represents, so to speak, the geometries of the coil windings of the flat coil. Here, the grooves can delimit or form at least two winding paths for inserting coil windings, whereby at least two coil winding patterns for flat coils with different coil properties are predetermined In the assembled state of the induction charger, the coil windings of the flat coil are expediently inserted into the grooves and fixed to the flat coil carrier, forming one of the predetermined coil winding patterns along a winding path of the at least two winding paths. This allows the flat coil to be realized or formed with predetermined coil properties. In this context, the invention understands the term “coil winding pattern” appropriately as the geometry of the coil windings of the flat coil. It is essential that the grooves define or form not just a single, but at least two or more, in particular different at least in sections or completely different, winding paths for inserting coil windings, along which coil windings can be inserted into the grooves in each case. The flat coil carrier thus offers the option of realizing flat coils in at least two or more different coil winding patterns, i.e., with different coil properties. In the assembled state of the induction charger, it is provided that the coil windings of the flat coil are inserted into the grooves and fixed to the flat coil carrier, forming one of the coil winding patterns thus predetermined along a winding path of the at least two predetermined winding paths. Not all grooves are necessarily filled with a coil winding. The flat coil carrier described above can usefully interact with the cover described above and the electronic device also described above in order to achieve an optimized magnetic coupling of the induction charger to a counter-induction charging unit.

Furthermore, the aforementioned cooling device can have a square design, which is particularly advantageous if the flat coil carrier also has a square design. The cooling device can also be equipped with coolant connections. Due to the square design of the cooling device, it can be rotated by 90°, 180°, 270°, or 360° in relation to the vertical axis, wherein a coolant connection position of the coolant connections changes by 90°, 180°, 270°, or 360° in relation to the vertical axis, whereby the cooling device can be adapted relatively easily and quickly to, for example, customer-specified vehicle connections for the coolant connections. The design of the cooling device can remain unchanged, which can have an advantageous effect on the manufacturing costs of the induction charger.

Furthermore, use of a vehicle-side induction charger according to the preceding description can be provided in a motor vehicle, wherein the motor vehicle is equipped with a traction battery and the induction charging device is integrated in the motor vehicle.

To summarize, it remains to be said: The present invention preferably relates to a vehicle-side induction charger for use in an induction charging unit of a motor vehicle which is set up for charging a traction battery and comprises the induction charger. The induction charger has an induction coil device for contactless energy transfer, an electronic device set up to operate the same, a cooling device set up to cool the induction coil device, and/or the electronic device, on which the electronic device is arranged on the one hand and the induction coil device on the other hand, and a cover enclosing at least the electronic device at least in sections. The induction coil device has a flat coil carrier and an electrically conductive flat coil of coil windings arranged on it. The cover is arranged on the flat coil carrier or on the cooling device in such a way that it spans the electronic device at least in sections or completely.

Other important features and advantages of the invention can be seen from the dependent claims, from the drawings and from the associated description of the figure based on the drawings.

It is understood that the above-mentioned features and those yet to be explained below can be used not only in the combination indicated in each case, but also in other combinations or on their own, without deviating from the scope of the present invention.

### BRIEF DESCRIPTION OF THE DRAWINGS

Preferred exemplary embodiments of the invention are shown in the drawings by way of example and will be explained in more detail in the following description, wherein identical reference signs refer to identical or similar or functionally identical elements.

They show, schematically in each case

FIG. 1 In a sectional view, a motor vehicle parked on a surface above a counter-induction charging unit with an induction charging unit set up for charging a traction battery not illustrated, which has a motor vehicle-side induction charger according to the invention according to a first exemplary embodiment in an assembled state,

FIG. 2A perspective view of the vehicle-side induction charger from FIG. 1, but without the vehicle,

FIG. 3A perspective view of a vehicle-side induction charger according to a further exemplary embodiment,

FIG. 4A perspective view of a vehicle-side induction charger according to a further exemplary embodiment,

FIG. 5 Top view of the vehicle-side induction charger as shown in FIG. 4, looking in the direction of an arrow V drawn there,

FIG. 6A perspective view of a vehicle-side induction charger according to a further exemplary embodiment,

FIG. 7 Top view of the vehicle-side induction charger as shown in FIG. 6, looking in the direction of arrow VII drawn there,

FIG. 8A perspective view of a vehicle-side induction charger according to a further exemplary embodiment,

FIG. 9 Top view of the vehicle-side induction charger as shown in FIG. 8, looking in the direction of an arrow IX drawn there,

FIG. 10A perspective view of a vehicle-side induction charger according to a further exemplary embodiment,

FIG. 11A plan view of the vehicle-side induction charger as shown in FIG. 10, looking in the direction of an arrow XI drawn there,

FIG. 12A perspective view of a vehicle-side induction charger according to a further exemplary embodiment,

FIG. 13A top view of the induction charger on the vehicle side as shown in FIG. 12, looking in the direction of an arrow XIII drawn there,

FIG. 14A perspective view of a vehicle-side induction charger according to a further exemplary embodiment,

FIG. 15A plan view of the vehicle-side induction charger as shown in FIG. 14, looking in the direction of an arrow XV drawn there,

FIG. 16A perspective view of a vehicle-side induction charger according to a further exemplary embodiment,

FIG. 17A plan view of the vehicle-side induction charger as shown in FIG. 16, looking in the direction of an arrow XVII drawn there,

FIGS. 18 to 20 Each show an electronic device of an induction charger according to a further exemplary embodiment,

FIG. 21A perspective view of a vehicle-side induction charger according to a further exemplary embodiment and finally the

FIG. 22 Plan view of the vehicle-side induction charger as shown in FIG. 21, looking in the direction of an arrow XXI drawn there,

FIG. 23 Top view of a flat coil carrier of the induction coil device of the induction charger according to an exemplary embodiment.

### DETAILED DESCRIPTION

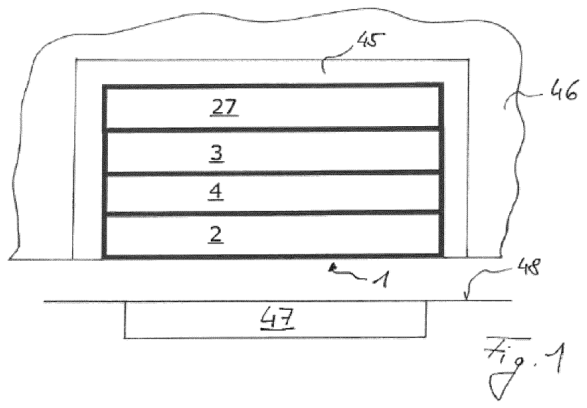

FIGS. 1 through 23 show several preferred exemplary embodiments of an induction charger designated as a whole by the reference numeral 1, each of which can be used in a vehicle-side induction charging unit of a motor vehicle.

In FIG. 1, a highly simplified sectional view shows a motor vehicle 46 parked on a surface 48 above a counter-induction charging unit 47, which is only partially illustrated and is equipped with an induction charging unit 45 which is set up for charging an unillustrated traction battery of the motor vehicle 46 and which has a motor vehicle-side induction charger 1 according to a first exemplary embodiment and possibly further components. The induction charger 1 is set up in the assembled state indicated in FIG. 1 and positioned above the counter-induction charging unit 47, which is arranged fixedly on the base 48, in such a way that it realizes an optimum magnetic coupling with the counter-induction charging unit 47, by means of which energy can be transmitted contactlessly and, if necessary, bidirectionally between the counter-induction charging unit 47 and the induction charging unit 45.

In order to be able to realize said magnetic coupling or bidirectional energy transfer, the induction charger 1 has separate components indicated by four boxes, namely an induction coil device 2, which accomplishes the actual contactless energy transfer, an electronic device 3 set up to operate the same, a cooling device 4 set up to cool the induction coil device 2 and the electronic device 3, and a cover 27. In FIG. 1 it can be seen that the electronic device 3 is arranged on the cooling device 4 on the one hand and the induction coil device 2 on the other; the cooling device 4 is sandwiched, so to speak. In practice, it may be expedient if the induction coil device 2 is arranged on the side of the cooling device 4 facing the substrate 48 and the electronic device 3 is arranged on an opposite side of the cooling device 4 facing away from the substrate 48. The cover 27 is designed to protect the induction coil device 2 and the electronic device 3 in particular from electromagnetic interference, for which purpose it completely covers and encloses them, for example, so that optimum shielding is achieved. Due to the design of the cover 27 described in more detail below, the cover 27 can be relatively compact. FIGS. 2, 3, 4, 6, 8, 10, 12, 14, and 16 each show covers 27 according to different exemplary embodiments, which are shown in FIGS. 5, 7, 9, 11, 13, 15, and 17 in a top view, so that all relevant design details are clearly visible.

With reference to FIG. 2, it can be seen that an induction coil device 2 and an electronic device 3, a cooling device 4 and a cover 27 can be recognized. The induction coil device 2 has a flat coil carrier 6 and an electrically conductive flat coil 8 consisting of coil windings 9 arranged thereon, wherein the cover 27 is fixed to the cooling device 4, which can be realized by a cooling plate, so that it spans the electronic device 3. The cover 27 projects away from the flat coil carrier 6 and the cooling device 4 in a height direction 35 along a vertical axis 52 aligned orthogonally with respect to the flat coil carrier 6 and the cooling device 4. A longitudinal axis 55 orthogonal to the vertical axis 52 and a transverse axis 56 orthogonal to the vertical axis 52 and the longitudinal axis 55 are defined at the vertical axis 52, wherein the longitudinal axis 55 defines a longitudinal direction 57 and the transverse axis 56 defines a transverse direction 58. The illustrated cover 27 is adapted to an outer contour of the electronic device 3, which in the present case is defined in FIG. 2 by a dashed box illustrated electronic components 60 of the electronic device 3, in such a way that it can be relatively compact. The adaptation can be achieved by the cover 27 spanning the electronic device 3 with horizontal wall sections 53 extending transversely to the vertical axis 52 and with vertical wall sections 54 extending parallel to the vertical axis 52, wherein the vertical wall sections 54 and/or the horizontal wall sections 53 each have a predetermined or predeterminable gap distance, e.g., a few millimeters, between them and an electronic component 60 of the electronic device 3. The horizontal wall sections 53 and the vertical wall sections 54 of the cover 27 are assigned electrical supply connections 61 of the electronic device 3 and coolant connections 62 of the cooling device 4, which pass completely through them. The horizontal wall sections 53 and the vertical wall sections 54 are further guided with a minimum gap distance, not illustrated, around the electrical supply connections 61 of the electronic device 3 and the coolant connections 62 of the cooling device 4, forming an electrical connection base 64 and a cooling connection base 65.

In FIG. 2, the cooling connection base 65 is indicated twice by a box to show two different alternative positions for the cooling connection base 65, rotated by 90° with respect to the vertical axis 55. It should also be mentioned that the cover 27 is designed as a square cover 67, which means that it forms an undesignated rectangular base body, above which the electrical connection base 64 and cooling connection base 65 described above project in the height direction 35. FIG. 2 also shows that the induction charger 1 is equipped with fasteners 77 arranged on the flat coil carrier 6 and/or the cooling device 4, by means of which the induction charger 1 can be detachably or non-detachably fastened to a motor vehicle 46. As an example, it is provided that the fasteners 77 are realized by four separate direct screwing projections 78, which project radially outwards away from the flat coil carrier 6 and the cooling device 4 with respect to the vertical axis 52. Each direct screwing projection 78 has a projection 79 with at least one through hole 80 oriented in the height direction 35, which could also be designed as a threaded hole. The projections 79 are each realized by a separate rectangular support arm 81, which are either integral with the flat coil carrier 6 and the cooling device 4 or are retrofitted as a separate unit. The through-holes 80 are each arranged at the distal end of a support arm 81.

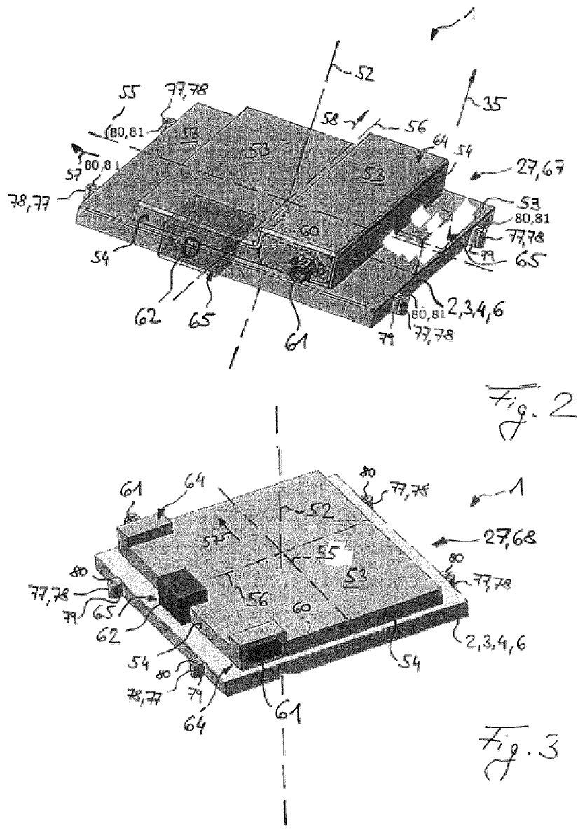

FIG. 3 shows a slightly redesigned induction charger 1 compared to the induction charger 1 in FIG. 2. It differs from the induction charger 1 illustrated in FIG. 2 in that the cover 27 is now designed as a rectangular cover 68, which means that it forms an undesignated rectangular cuboid base body. Instead of a single electrical connection socket 64 as in FIG. 2, two electrical connection sockets 64 now protrude above the rectangular cover 68, positioned opposite each other on the cover 27. A single cooling connection base 65 is arranged in the longitudinal direction 57 between these two electrical connection bases 64.

FIGS. 4 and 5 show another induction charger 1 with a slightly modified design compared to the induction charger 1 in FIGS. 2 and 3. It differs from the induction chargers 1 illustrated in FIGS. 2 and 3 in that the cover 27 is again designed as a square cover 67, which again means that it forms an undesignated square rectangular base body, but now the electrical connection base 64 and cooling connection base 65 and fasteners 77, which are raised above the square cover 67, are hidden so that a fixing flange 70, which is arranged integrally on the cover 27 and completely circumferential with respect to the vertical axis 52 and is hidden in FIGS. 1 to 3 can be recognized. The fixing flange 70 has several through-holes marked with the number 71, which are arranged on the fixing flange 70 around the vertical axis 52 and pass completely through it in the height direction 35. Fastening screws 84 can be passed through the through-holes 71 and screwed to the flat coil carrier 6 and/or the cooling device 4. As a result, the cover 27 can be mounted in contact and, if necessary, with the aid of adhesive in a fluid-tight manner on the flat coil carrier 6 or the induction coil device 2 and/or on the cooling device 4. The cover 27 can in particular be fixed to be detachable or to be non-detachable.

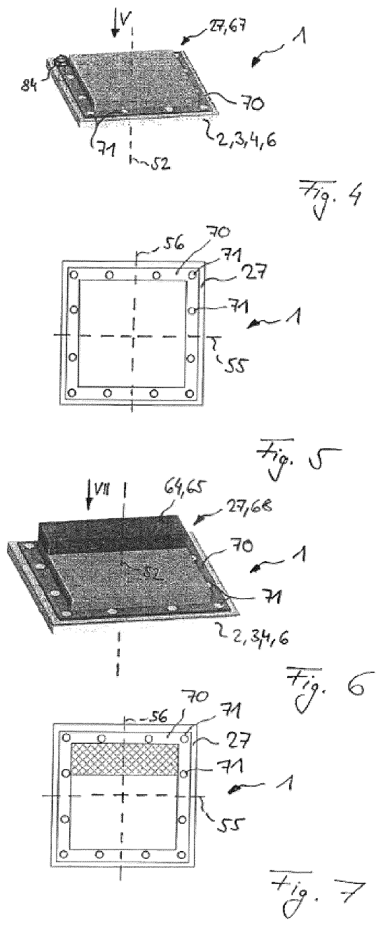

FIGS. 6 and 7 show a slightly redesigned induction loading device 1 compared to the previous induction chargers 1. It differs from the previously illustrated induction chargers 1 in particular in that the cover 27 is now designed as a rectangular cover 68, which means that it forms an undesignated rectangular cuboid base body. A single base protrudes above the rectangular cover 68, which forms an electrical connection base 64 and a cooling connection base 65, so to speak.

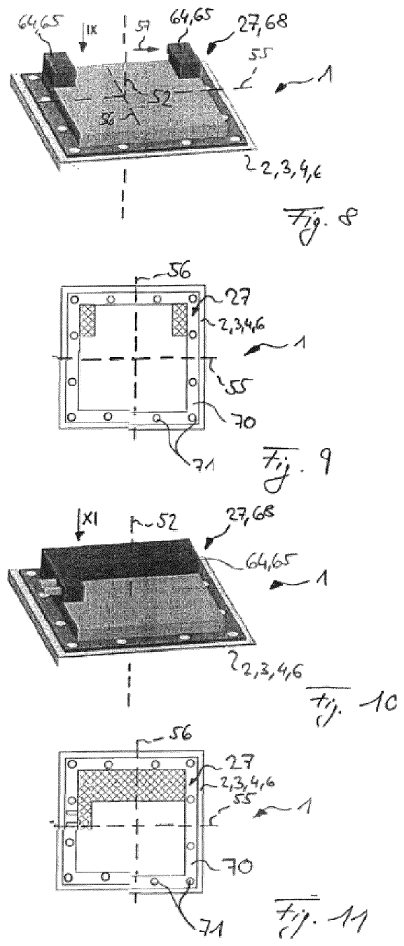

FIGS. 8 and 9 show a slightly redesigned induction charger 1 compared to the previous induction chargers 1. It differs from the previously illustrated induction chargers 1 in particular in that the cover 27, which is designed as a rectangular cover 68, now has two bases which are positioned opposite one another on the cover 27 in the longitudinal direction 57 parallel to the longitudinal axis 55. The two sockets can each form an electrical connection socket 64 or a cooling connection socket 65. It is also conceivable that each socket forms both an electrical connection socket 64 and a cooling connection socket 65. However, the electrical supply connections 61 and the coolant connections 62 are not shown.

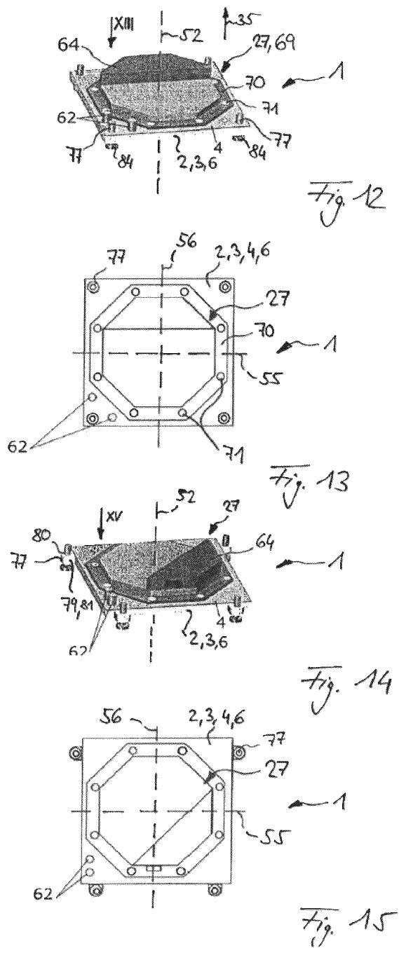

FIGS. 10 and 11 show a slightly redesigned induction charger 1 compared to the previous induction chargers 1. It differs from the previously illustrated induction chargers 1 in particular in that the cover 27, which is again designed as a rectangular cover 68, now has a single base which combines an electrical connection base 64 and a cooling connection base 65.

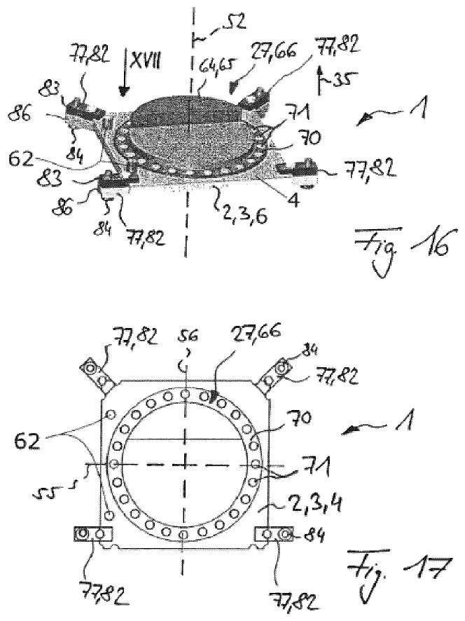

FIGS. 12 and 13 show a slightly redesigned induction charger 1 compared to the previous induction chargers 1. It differs from the previously illustrated induction chargers 1 in particular in that the cover 27 is now designed as an octagonal cover 69, which means that it has an undesignated octagonal base body. A base, which represents an electrical connection base 64, projects above this in the height direction 35. Furthermore, it is provided that the coolant connections 62 are in vertical contact with the cooling device 4, so that a fluid coolant flows or can flow through it directly and without passing through the cover 27. These coolant connections 62 are thus located in an area of the coolant device 4 not covered or covered by the cover 27. The illustrated fixing flange 70 follows the shape of the cover so that it has an octagonal shape. Deviating from the preceding exemplary embodiments, it is further provided that the fasteners 77 are now formed by the induction coil device 2, the electronic device 3 and the cooling device 4, so that no projections 79 or support arms 81 are provided here. This allows the induction charger 1 to be relatively compact and lightweight.

FIGS. 14 and 15 show a slightly redesigned induction charger 1 compared to the previous induction chargers 1. It differs from the induction chargers 1 illustrated in FIGS. 12 and 13 in particular in that the cover 27 is now rotated by 125° with respect to the vertical axis 55 and also in that the fasteners 77 now again have projections 79 or support arms 81 with through-holes 80.

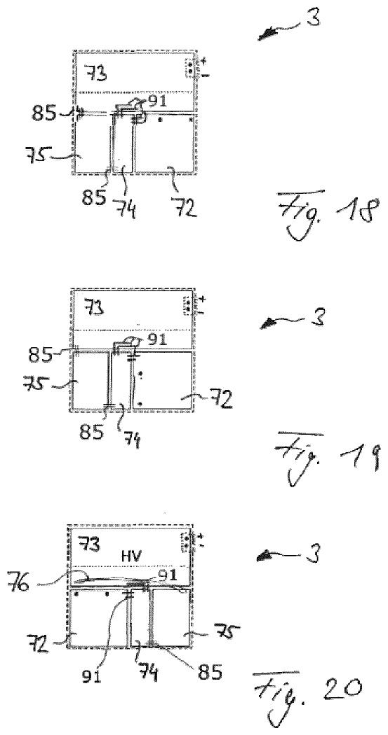

FIGS. 16 and 17 show a slightly redesigned induction charger 1 compared to the previous induction chargers 1. It differs from the previously illustrated induction chargers 1 in particular in that the cover 27 is now designed as a circular cover 66, which means that it has an undesignated cylindrical base body. A base projects above this in the height direction 35, forming in particular a circular chord. Once again, this base forms both an electrical connection base 64 and a cooling connection base 65. The illustrated fixing flange 70 is ring-shaped, so it follows the shape of the cover. The through-holes 71 are thus arranged in a circle around the vertical axis 52 on the fixing flange 70. This cover 27 can, for example, be rotated about the vertical axis 52 in 15° steps, so that different positions of the cover 27 and in particular of the base 64 can be realized. Furthermore, it can be seen that the fasteners 77 are exemplarily formed by four clamps 82 arranged on the cover 27 and/or on the flat coil carrier 6 and/or on the cooling device 4. Each clamp 82 has a clamping body 83, a spacer 86 arranged loosely on the cover 27 and/or on the flat coil carrier 6 and/or on the cooling device 4 and projecting radially outwards with respect to the vertical axis 52, and a fastening screw 84. When the induction charger 1 is mounted on the vehicle, the clamping body 83 is supported on the cover 27 and/or on the flat coil carrier 6 and/or on the cooling device 4 in a contacting manner and clamps the cover 27 and/or the flat coil carrier 6 and/or the cooling device 4 in the height direction 35 by means of one of the fastening screws 84 screwed in on the vehicle. It can also be seen that the clamps 82 are mounted in different directions in the corner area of the induction charger 1. This is possible because the entire corner area is designed for attachment to a motor vehicle due to the internal structural design. In the case shown, the clamping body 83 can be mounted in three different positions in a corner area without compromising the mechanical integrity of the induction charger 1. The respective positions can be defined by form-fitting design elements (e.g., notches in this case).

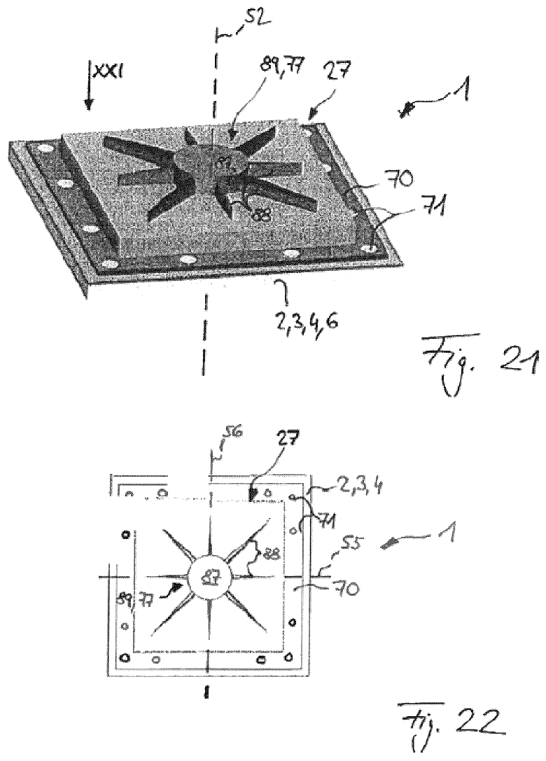

FIGS. 18 through 20 each show an electronic device 3 of an induction charger 1 according to a further exemplary embodiment, each of which has four separate and printed circuit boards 72, 73, 74, 75. The printed circuit boards 72, 73, 74, 75 are electrically connected to each other via electrical HV conductors 91 and LV conductors 85. A printed circuit board titled as a first printed circuit board 72 of these printed circuit boards 72, 73, 74, 75 forms a capacitor board having a plurality of separate capacitor banks, a second printed circuit board 73 of these printed circuit boards 72, 73, 74, 75 forms a high-voltage signal processing board which realizes high-voltage signal processing and high-voltage signal conversion. Furthermore, a third printed circuit board 74 of these printed circuit boards 72, 73, 74, 75 forms a further capacitor board which has at least one adjustable capacitor. The last circuit board is designated as the fourth circuit board 75. It forms a communication board that has control and regulation electronics for the operation of at least the flat coil 8. The printed circuit boards 72, 73, 74, 75, which are connected to HV conductors 91, are designed so that standardized, uniform conductors can be used in each case. The LV conductors 85, on the other hand, can be realized as flexible LV communication connections 76 (e.g., by thin strands). The printed circuit boards 72, 73, 74, 75 illustrated in FIGS. 18 to 20 are arranged in different positions and orientations in order to be able to realize an optimum magnetic coupling and/or a preferred electromagnetic behaviour according to the respective given framework conditions. Furthermore, it is possible to change the position of the platforms, which can be understood as bases 64, 65, of the cover 27 by displacing the tall electronic components enclosed thereby, thus facilitating integration into a motor vehicle if necessary. At least the second and first printed circuit boards 72, 73 each have an electrical supply connection 90 indicated by a +/− symbol in FIGS. 18 through 20; it can be imagined that these are, for example, the aforementioned electrical supply connections 61.

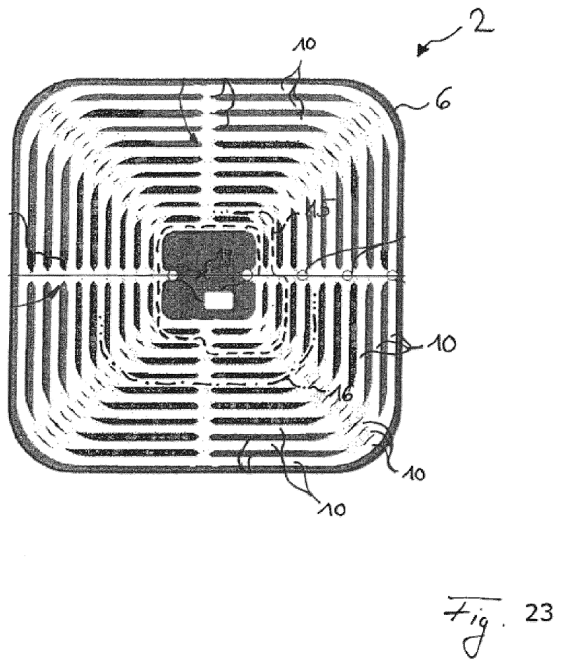

FIGS. 21 and 22 show an induction charging device 1 whose fasteners 77 is formed by a carrier 89 arranged integrally on the cover 27. The support 89 has a support rod 87, which can be anchored on the vehicle side, for example by bolting or welding or bonding, and rib-like support struts 88, which engage integrally with the support rod 87 and extend in a star shape over the cover 27, which primarily serve to distribute the load from the support rod 87 to the cover 27 but also, in particular if the support struts 88 are integrally formed on the cover 27 and the support rod 87, to stiffen the support rod 87 and the cover 27.

FIG. 23 shows a plan view of a flat coil carrier 6 of the induction coil device 2 of the induction charger 1 according to an exemplary embodiment. It can be seen that the flat coil carrier 6 has contiguous grooves 10, into which the coil windings 9 of the flat coil 8 can be inserted along a winding path 15, 16 extending through the grooves 10, forming a coil winding pattern of the flat coil 8 that determines the coil properties of the flat coil 8. The grooves 10 define at least two different winding paths 15, 16 for inserting coil windings 9, whereby at least two coil winding patterns for flat coils 8 with different coil properties are provided. In the assembled state of the induction charger 1, however, the coil windings 9 of the flat coil 8 are inserted into the grooves 10 and fixed to the flat coil carrier 6, forming a single one of the predetermined coil winding patterns along a single winding path 15, 16 of the at least two winding paths 15, 16.

1. A vehicle-side induction charger, comprising:
an induction coil device for contactless energy transmission, an electronic device set up for operating the induction coil device, a cooling device set up for cooling the induction coil device and/or the electronic device, on which the electronic device is arranged on the one hand and the induction coil device on the other hand, and with a cover enclosing the electronic device at least in sections,
wherein the induction coil device has a planar flat coil carrier and an electrically conductive flat coil of coil windings arranged thereon,
wherein the cover is arranged on the flat coil carrier or on the cooling device and spans the electronic device,
wherein the cover defines a vertical axis orthogonally aligned with respect to the flat coil carrier and/or the cooling device in a height direction pointing orthogonally away from the flat coil carrier and/or the cooling device,
wherein the induction coil device, the cooling device, the electronics device and the cover are each rotatable about the vertical axis and positioned in different angular positions with respect to the vertical axis, and
wherein the induction coil device, the cooling device, the electronic device and the cover can be fixed to each other in their respective angular positions.

2. The vehicle-side induction charger according to claim 1, wherein angles of 5°, 10°, 15°, 20°, 25°, 30°, 35°, 40°, 45°, 90°, or 180° are spanned between the different angular positions in which the induction coil device, the cooling device, the electronics device and the cover can be positioned, so that the induction coil device, the cooling device, the electronic device and the cover can be positioned in 5°, 10°, 15°, 20°, 25°, 30°, 35°, 40°, 45°, 90°, and 180° steps with respect to the vertical axis and can be fixed to one another.

3. The vehicle-side induction charger according to claim 1, wherein:
the cover is adapted to an outer contour of the electronic device in that it spans the electronic device with a wall, the wall defining a predetermined or predeterminable gap between the and an electronic component of the electronic device, and/or
the cover is adapted to an outer contour of the electronic device in that it spans the electronic device with horizontal wall sections extending transversely to the vertical axis and with vertical wall sections extending parallel to the vertical axis, wherein the vertical wall sections and/or the horizontal wall sections each have a predetermined or predeterminable gap distance between them and an electronic component of the electronic device.

4. The vehicle-side induction charger according to claim 3, wherein:
the horizontal wall sections and/or the vertical wall sections of the cover are assigned electrical supply connections of the electronic device and/or coolant connections of the cooling device, which pass through the same, and/or
the horizontal wall sections and/or the vertical wall sections have a predetermined or predeterminable minimum gap distance between them and the electrical supply connections and/or the coolant connections.

5. The vehicle-side induction charger according to claim 1, wherein the cooling device includes a cooling plate having a plurality of initially closed feedthrough positions, two of the plurality of initially closed feedthrough positions being opened to provide passages for coolant connections.

6. The vehicle-side induction charger according to claim 3, wherein the horizontal wall sections and/or the vertical wall sections are guided with a minimum gap spacing around the electrical supply connections of the electronic device and/or the coolant connections of the cooling device, defining a raised electrical connection base and/or a raised cooling connection base.

7. The vehicle-side induction charger according to claim 1, wherein the cover is a circular cover or a square cover or a rectangular cover or an octagonal cover.

8. vehicle-side induction charging device according to claim 1, wherein:
the cover defines a vertical axis orthogonally aligned with respect to the flat coil carrier or the cooling device in a height direction pointing orthogonally away from the flat coil carrier and/or the cooling device, and
the cover is structured to be point-symmetrical with respect to the vertical axis or mirror-symmetrical with respect to a longitudinal axis orthogonal to the vertical axis.

9. The vehicle-side induction charging device according to claim 1, wherein:
the cover defines a vertical axis orthogonally aligned with respect to the flat coil carrier or the cooling device in a height direction pointing orthogonally away from the flat coil carrier and/or the cooling device,
the cover has an integral fixing flange which revolves with respect to the vertical axis and which, in a state of the cover mounted on the flat coil carrier or on the cooling device, faces the flat coil carrier and the cooling device and is arranged in contact therewith,
the integral fixing flange has through-holes for fastening screws arranged around the vertical axis, and
the through-holes for releasably fixing the cover to the flat coil carrier or the cooling device are each fitted with a fastening screw when the cover is mounted on the flat coil carrier or on the cooling device.

10. The vehicle-side induction charger according to claim 9, wherein the through-holes of the fixing flange are structured to be point-symmetrical with respect to the vertical axis or mirror-symmetrical with respect to a longitudinal axis orthogonal to the vertical axis.

11. The vehicle-side induction charger according to claim 1, wherein:
the electronic device has a plurality of separate printed circuit boards which are electrically connected to one another via electrical conductors,
a first printed circuit board of the plurality of printed circuit boards forms a capacitor board having a plurality of separate capacitor banks,
a second printed circuit board of the plurality of printed circuit boards forms a high-voltage signal processing board which realizes high-voltage signal processing and high-voltage signal conversion,
a third printed circuit board of the plurality of printed circuit boards forms a further capacitor board which has at least one adjustable capacitor, and
wherein a fourth printed circuit board of the plurality of printed circuit boards forms a communication board which has control and regulation electronics for the operation of at least the flat coil.

12. The vehicle-side induction charging device according to claim 11, wherein the electrical conductors of the electronic device form low-voltage conductor and high-voltage conductors, via which the plurality of printed circuit boards are electrically connected or can be connected.

13. The vehicle-side induction charger according to claim 12, wherein:
the plurality of printed circuit boards can be positioned in different angular positions by rotation about the vertical axis and/or rotation about a transverse axis perpendicular to the vertical axis,
the plurality of printed circuit boards can be electrically communicatively connected via the high-voltage conductors and/or the low-voltage conductors, and/or
the same high-voltage conductors can be used for the electrical connections between the first, second and third printed circuit boards, even in different angular positions.

14. The vehicle-side induction charger according to claim 1, wherein fasteners are assigned to the cover and/or the flat coil carrier and/or the cooling device, the positioning and alignment of which fasteners are adapted within predetermined areas of the induction charger, wherein the induction charger can be detachably or non-detachably fastened to a motor vehicle via the fasteners.

15. The vehicle-side induction charger according to claim 14, wherein:
the cover defines a vertical axis orthogonally aligned with respect to the flat coil carrier or the cooling device in a height direction pointing orthogonally away from the flat coil carrier and/or the cooling device,
the fasteners are formed by a plurality of separate direct screwing projections arranged on the cover and/or on the flat coil carrier and/or on the cooling device,
wherein each direct screwing projection has a projection projecting radially outwards transversely to the vertical axis from the cover and/or from the flat coil carrier and/or from the cooling device with at least one through hole or a threaded bore, wherein the at least one through hole or the threaded bore of the plurality of screwing projections are oriented with their openings in the vertical direction, and/or
the projections with through hole or threaded hole are each defined by a cuboid support arm,
wherein the through-holes or threaded holes of which are arranged in each case at the distal end of a support arm or in the direction transverse to the vertical axis in the radially outer, last third of a respective support arm, and/or
the fasteners are formed by a plurality of clamps arranged on the cover and/or on the flat coil carrier and/or on the cooling device,
wherein each clamp has a clamping body, a spacer arranged loosely on the cover and/or on the flat coil carrier and/or on the cooling device and projecting radially outwards with respect to the vertical axis, and a fastening screw, and
wherein the clamping body is in contact with the cover and/or the flat coil carrier and/or the cooling device and clamps the cover and/or the flat coil carrier and/or the cooling device in the height direction via one of the fastening screws screwed in on the vehicle side.

16. The vehicle-side induction charger according to claim 1, wherein:
the flat coil carrier has contiguous grooves into which the coil windings of the flat coil can be inserted along a winding path extending through the grooves, forming a coil winding pattern of the flat coil which determines the coil properties of the flat coil,
wherein the grooves delimit or form at least two winding paths for inserting coil windings, whereby at least two coil winding patterns for flat coils with different coil properties are provided, and
wherein, in an assembled state of the induction charger, the coil windings of the flat coil are inserted into the grooves along a winding path of the at least two winding paths to form one of the predetermined coil winding patterns and are fixed to the flat coil carrier.

17. The vehicle-side induction charger according to claim 14, wherein the fasteners are disposed in one or more corners of the cover and/or the flat coil carrier and/or the cooling device.

18. A motor vehicle comprising the vehicle-side induction charger according to claim 1.

19. An induction charging unit of a motor vehicle for charging a traction battery, comprising:
a vehicle-side induction charger including an induction coil device for contactless energy transmission, an electronic device configured for operating the induction coil device, a cooling device structured and arranged for cooling the induction coil device and/or the electronic device, on which the electronic device is arranged on the one hand and the induction coil device on the other hand, and with a cover enclosing the electronic device at least in sections;
the induction coil device including a planar flat coil carrier and an electrically conductive flat coil of coil windings arranged thereon;
the cover arranged on the flat coil carrier or on the cooling device and spans the electronic device;
wherein the cover is orthogonally aligned with respect to the flat coil carrier and/or the cooling device in a height direction pointing orthogonally away from the flat coil carrier and/or the cooling device;
wherein the induction coil device, the cooling device, the electronics device and the cover are each rotatable about the vertical axis and positioned in different angular positions with respect to the vertical axis; and
wherein the induction coil device, the cooling device, the electronic device and the cover can be fixed to each other in their respective angular positions.

20. The induction charging unit according to claim 19, wherein:
the cover is adapted to an outer contour of the electronic device in that it spans the electronic device with a wall, the wall defining a predetermined or predeterminable gap between the and an electronic component of the electronic device; and/or
the cover is adapted to an outer contour of the electronic device in that it spans the electronic device with horizontal wall sections extending transversely to the vertical axis and with vertical wall sections extending parallel to the vertical axis, wherein the vertical wall sections and/or the horizontal wall sections each have a predetermined or predeterminable gap distance between them and an electronic component of the electronic device.
